(19) United States
(12) Patent Application Publication
(10) Pub. No.: US 2024/0408923 A1
(43) Pub. Date: Dec. 12, 2024

(54) DEVICE FOR VEHICLE TIRE WITH INFLATION VALVE AND ELECTRONIC PRESSURE MONITORING MODULE

(71) Applicant: Continental Automotive Technologies GmbH, Hannover (DE)

(72) Inventors: Stéphane COUARRAZE, Toulouse (FR); Frédéric GAUGAIN, Leguevin (FR); Yves MAXCH, Pelleport (FR); Gilles CAPDEPON, Vernet (FR)

(73) Assignee: Continental Automotive Technologies GmbH, Hannover (DE)

(21) Appl. No.: 18/678,370

(22) Filed: May 30, 2024

(30) Foreign Application Priority Data
Jun. 8, 2023 (FR) 2305783

(51) Int. Cl. B60C 23/04

(52) U.S. Cl. CPC B60C 23/0494; B60C 23/0408

(57) ABSTRACT

A device for a motor vehicle tire including an inflation valve comprising an elastomer body (2) having an internal shoulder (6) coming to bear in the tire on a rim edge, and including an electronic module of a system for monitoring pressure inside the tire that is disposed in a housing (12) made of two half-shells assembled along a parting line, the valve including an elastic ring (14) connected to the internal shoulder of the body (6), receiving the housing (12) of the electronic module therein to hold same, surrounding the parting line between the half-shells thereof.

### CROSS REFERENCE TO RELATED APPLICATIONS

This application claims priority to French Patent Application No. 2305783, filed Jun. 8, 2023, the contents of such application being incorporated by reference herein.

### FIELD OF THE INVENTION

The present invention relates to a device for a motor vehicle tire including an electronic module of a system for monitoring the pressure of the tire and an inflation valve, a wheel fitted with such a device, and a method for assembling this type of wheel.

### BACKGROUND OF THE INVENTION

A known type of tire pressure monitoring system (TPMS), disclosed notably by document FR-A1-3084288, incorporated herein by reference, includes a valve made of an elastomer containing a rigid upstream tube fitted with a non-return valve to enable inflation, and a rigid downstream tube extending the upstream tube, with a seal between the two tubes.

In a configuration shown in FIG. 5 of this document, an electronic module of a system for monitoring the pressure of the tire including a pressure sensor, an electric power supply battery and an electronic circuit including a radio transmitter is fastened to the end of the downstream tube entering the rim using a screw screwed into a tapped thread formed in the axial hole in this tube. The downstream tube of the valve is thus used to form an attachment point for the electronic housing inside the tire, which obviates the need to provide a separate system for fastening the housing directly to the rim.

Furthermore, the housings of electronic pressure monitoring modules disposed inside tires must have a high degree of fluidtightness to protect the internal components from contamination inside the tire, such as moisture carried in the inflation air that condenses, dust present during mounting of the tire, or the grease used to facilitate the mounting of the tire to slide the belt thereof over the edge of the rim, which may be corrosive.

Furthermore, since European regulations require tire pressure monitoring systems to be installed on all four wheels of motor vehicles, low-cost modules are needed to limit the impact on the total price of vehicles.

To make these electronic module housings, it is known to make two half-shells to contain the components, and then to assemble them using an industrial mechanical system to ensure the seal between these two parts. In particular, a peripheral gasket between the half-shells and assembly components compressing this gasket with screws or rivets may be provided. The housing can also be sealed, for example by gluing or welding the half-shells, which guarantees both mechanical strength and fluidtightness.

However, these housing sealing systems are expensive, notably requiring attached assembly components incurring assembly and provisioning costs, or implementation of a sealing method.

Furthermore, these electronic modules are then difficult or impossible to repair on account of the difficulties in opening and closing the housing while ensuring fluidtightness, and they contain components that can wear out, such as the electric power supply battery, which has to be changed after a certain usage time, or components that are easy to repair. This makes the electronic module a consumable product that has to be thrown away in the event of minimal wear or failure, with limited repair options, which generates cost issues and environmental issues related to the manufacture of a new housing and the mandatory reprocessing of the old housing. In particular, the battery is usually a lithium battery that requires special recycling, which is costly.

The present invention is notably intended to overcome these problems in the prior art.

### SUMMARY OF THE INVENTION

For this purpose, a device is proposed for a motor vehicle tire including an inflation valve comprising an elastomer body having an internal shoulder coming to bear in the tire on a rim edge, and including an electronic module of a system for monitoring pressure inside the tire that is disposed in a housing made of two half-shells assembled along a parting line, this device being noteworthy in that the valve includes an elastic ring connected to the internal shoulder of the body, receiving the housing of the electronic module therein to hold same, surrounding the parting line between the half-shells thereof.

One advantage of this device is that the elastomer of the body, which is cheap as this material is molded, on account of its elasticity, performs a function of holding the housing of the electronic module inside the tire, and also forms a protective contour surrounding the parting line between the two half-shells of this housing.

This provides a simple housing that is cheap to make, for example with half-shells that can be quickly snap-fitted together, and then easy to open for maintenance, repair or recycling. When the module is subsequently brought back into service, positioning and fastening the housing in the ring of the valve automatically ensures that it is held and protected as when originally installed.

The device for a tire according to an aspect of the invention may further include one or more of the following features, which may be combined with one another.

Advantageously, the elastic ring forms a seal about the half-shells, protecting the parting line.

Advantageously, the housing includes an outer groove surrounding the parting line thereof, receiving the elastic ring.

In this case, the outer groove advantageously has a hollow circular arc section.

According to one embodiment, the elastic ring has a cross section forming a circle fitting into the groove.

According to another embodiment, the elastic ring has a cross section comprising a rounded part fitting into the outer groove, extended on each side by a lip that covers the edge of the housing beyond the outer groove thereof.

Advantageously, the housing includes a hole receiving the end of a rigid tube of the valve projecting into the elastic ring.

Advantageously, the two half-shells of the housing are assembled together with an unsealed join.

Advantageously, the elastic ring is formed by one and the same mold with the elastomer valve body.

An aspect of the invention also relates to a motor vehicle wheel comprising a tire mounted on a rim fitted with an inflation valve, which is noteworthy in that it includes a device for a tire including any one of the features set out above, with the electronic module housing thereof fastened in the elastic ring of the valve.

An aspect of the invention also relates to a method for assembling a wheel including the aforementioned feature, which is noteworthy in that it comprises, before the tire is mounted on the rim, a step of inserting the valve body into a hole in the rim, and a step of fastening the housing of the electronic module in the elastic ring of the valve body.

### BRIEF DESCRIPTION OF THE DRAWINGS

Aspects of the invention can be better understood, and further features and advantages will become clearer from the description below, given by way of an example and with reference to the attached drawings, in which:

FIG. 1 shows a device for a tire according to an aspect of the invention,

FIG. 2 is an exploded view of this device,

FIG. 3 is a schematic view of this device in cross section through the electronic module,

FIG. 4 shows a device according to a variant,

FIG. 5 shows this device with part of the elastic ring cut away,

FIG. 6 is a schematic view of this device in cross section through the electronic module.

### DETAILED DESCRIPTION OF EXEMPLARY EMBODIMENTS

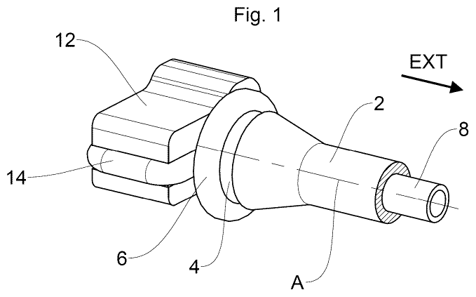

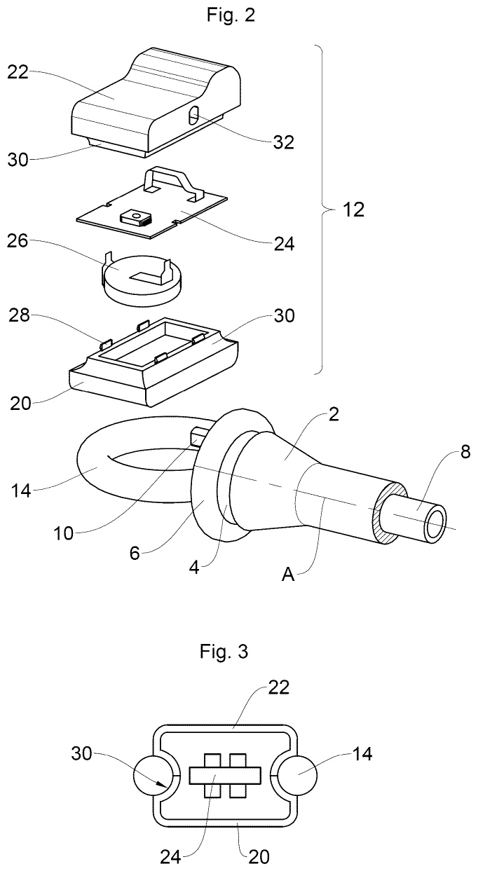

FIGS. 1, 2 and 3 show a valve having an elastomer body 2 disposed along a main axis A, comprising from a side outside the wheel EXT an elongate part including a rigid axial conduit 8 receiving an inflation air pressure from the tire, an annular groove 4 provided to fit into a hole in the metal sheet of a rim, and a shoulder 6 bearing against the inside of this metal sheet. The rigid conduit 8 is extended by an inner end 10 extending beyond the shoulder 6 to supply air to the tire.

A closed elastic ring 14 made in the same mold as the elastomer of the body 2 has a circular contour that is disposed in an axial plane of the valve. The elastic ring 14 has a round cross section that is constant, the inner end 10 of the rigid conduit 8 opening into this ring.

An electronic module of a system for monitoring the pressure of the tire includes a housing 12 comprising a lower half-shell 20 and an upper half-shell 22 made using plastic molds, forming a substantially square, thin housing once assembled. The housing 12 contains an electronic circuit board 24 wedged in this housing, bearing welded components comprising a pressure sensor, a radio transmitter, and an electric lithium battery 26 welded underneath this board.

The half-shells 20, 22 of the housing 12 are fitted onto one another along a flat parting line disposed in the thickness of the housing, internal lugs 28 ensuring the relative positioning thereof. The closed housing 12 has, about the contour thereof, an outer groove 30 having a constant hollow cross section forming a semicircle, which is centered on the parting line.

In the assembled state shown in FIG. 1, the housing 12 is inserted into the elastic ring 14 by stretching and deforming said ring to fit it into the outer groove 30 of matching shape, so that half of the section of said ring enters said groove. The hollow section of the groove 30 receiving the elastic ring 14 compressed therein holds the housing 12.

Stretching the elastomer ring 14 to surround the housing 12 creates enough compression on the surface of the two parts of the groove 30 formed by the two half-shells 20, 22 to seal these two parts and protect the parting line.

The upper half-shell 22 includes a hole 32 on one side that opens on the other side, without entering the inside of this housing, that is designed to receive, in a fitted manner, the end 10 of the rigid conduit 8 of the valve so as to position the housing on this valve, and to provide additional hold in addition to the hold provided by the elastic ring 14.

Inserting the end 10 of the rigid conduit 8 into the hole 32 of the previously assembled housing 12, then fitting this housing in the elastic ring 14 by stretching this ring enables simple and quick assembly that requires no additional fastening components, and that simultaneously holds the housing in the tire and provides a seal between the two half-shells 20, 22 thereof.

Furthermore, the electronic module can be removed simply and without tools for maintenance or repair by removing the housing 12 from the elastic ring 14 by deforming same. The housing 12, which is closed without gluing or welding, can then be opened quickly and cleanly, for example by removing closing clips, to enable work to be carried out therein, after which the housing can be closed by carrying out these operations in reverse. The half-shells 20, 22 are then resealed by reassembling the housing 12 in the elastic ring 14 of the valve fastened to the rim, with a quality identical to the original quality.

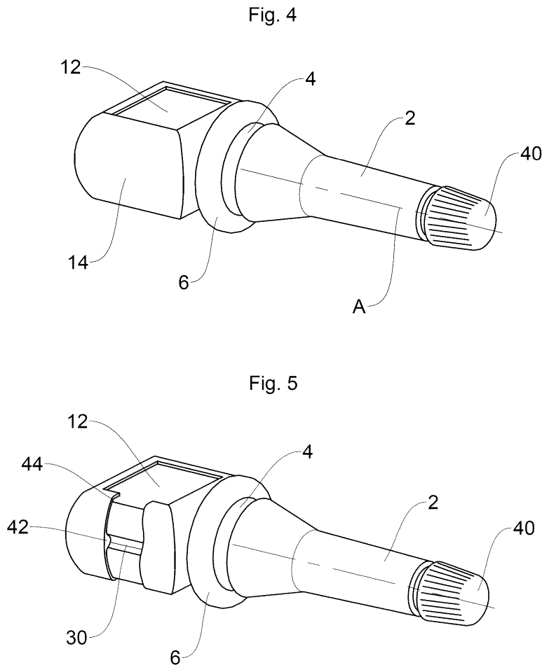

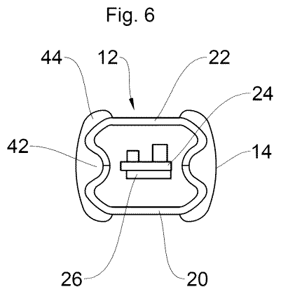

FIGS. 4, 5 and 6 show as a variant an elastomer valve body comprising, inside the tire, the elastic ring 14 of constant cross section with a rounded part in the form of a circular arc 42 oriented towards the inside of the ring that is fitted into the outer groove 30 of the housing 12, and a lip 44 on each side that covers the top or bottom rounded edge of this housing. In this configuration, the hole 32 and the end 10 of the rigid conduit 8 of the valve may be omitted, and the housing is then positioned and held on this valve only by the elastic element 14.

The outer end of the valve is shown with the protective cap 40 thereof closing the inflation orifice.

The internal rounded part of the section of the elastic ring 14 bears similarly and simultaneously on the two half-shells 20, 22, and a lip on each side bears against and covers the rounded edges of these half-shells to ensure greater fluidtightness.

The elastomer thus protects the contours of the housing 12 against potential impacts, notably during mounting of the tire.

1. A device for a motor vehicle tire including an inflation valve comprising an elastomer body having an internal shoulder coming to bear in the tire on a rim edge, and including an electronic module of a system for monitoring pressure inside the tire that is disposed in a housing made of two half-shells assembled along a parting line, wherein the valve includes an elastic ring connected to the internal shoulder of the body, receiving the housing of the electronic module therein to hold same, surrounding the parting line between the half-shells thereof.

2. The device for a tire as claimed in claim 1, wherein the elastic ring forms a seal about the half-shells, protecting the parting line.

3. The device for a tire as claimed in claim 2, wherein the housing includes an outer groove surrounding the parting line thereof, receiving the elastic ring.

4. The device for a tire as claimed in claim 3, wherein the outer groove has a hollow circular arc section.

5. The device for a tire as claimed in claim 3, wherein the elastic ring has a cross section forming a circle fitting into the groove.

6. The device for a tire as claimed in claim 3, wherein the elastic ring has a cross section comprising a rounded part fitting into the outer groove, extended on each side by a lip that covers the edge of the housing beyond the outer groove thereof.

7. The device for a tire as claimed in claim 1, wherein the housing includes a hole receiving the end (10) of a rigid tube of the valve projecting into the elastic ring.

8. The device for a tire as claimed in claim 1, wherein the two half-shells of the housing are assembled together with an unsealed join.

9. The device for a tire as claimed in claim 1, wherein the elastic ring is formed by one and the same mold with the elastomer valve body.

10. A motor vehicle wheel comprising a tire mounted on a rim fitted with an inflation valve, comprising a device for a tire as claimed in claim 1, including the electronic module housing thereof that is fastened in the elastic ring of the valve.

11. A method for assembling a wheel as claimed in claim 10, the method comprising, before the tire is mounted on the rim, a step of inserting the valve body into a hole in the rim, and a step of fastening the housing of the electronic module in the elastic ring of the valve body.

12. The device for a tire as claimed in claim 4, wherein the elastic ring has a cross section forming a circle fitting into the groove.

13. The device for a tire as claimed in claim 4, wherein the elastic ring has a cross section comprising a rounded part fitting into the outer groove, extended on each side by a lip that covers the edge of the housing beyond the outer groove thereof.
